(19) United States
(12) Patent Application Publication
(10) Pub. No.: US 2017/0198459 A1
(43) Pub. Date: Jul. 13, 2017

(54) HAZARD AVOIDANCE SYSTEM FOR A MACHINE

(71) Applicant: Caterpillar Inc., Peoria, IL (US)

(72) Inventor: Kenneth L. Stratton, Dunlap, IL (US)

(73) Assignee: Caterpillar Inc., Peoria, IL (US)

(21) Appl. No.: 14/993,672

(22) Filed: Jan. 12, 2016

(51) Int. Cl. E02F 9/26; E02F 9/20; E02F 9/24; B60R 21/34

(52) U.S. Cl. CPC E02F 9/261; B60R 21/34; E02F 9/262; E02F 9/2054; E02F 9/24

(57) ABSTRACT

A hazard avoidance system for a machine includes a profile monitoring device configured to determine a profile created by the machine, a position detection module configured to determine a position of the machine on the worksite and a controller communicably coupled to the profile monitoring device and the position detection module. The controller is configured to receive the profile determined by the profile monitoring device, receive the position of the machine, determine the profile as a hazard if the gradient of the profile is above a certain gradient and determine the location of the hazard and transmit location of the hazard and initiate preventive action in a second machine operating in proximity to the machine on the worksite.

### TECHNICAL FIELD

The present disclosure relates to a construction machine. In particular, the present disclosure relates to a hazard avoidance system for a construction machine.

### BACKGROUND

Machines, for example, motor graders, dozers, compactors, pavers, and profilers to name a just a few, are used for geographic surface altering operations. Such machines typically operate at construction sites which were previously manually surveyed, and staked according to construction site plans. Before the surface altering operation, the construction site is frequently inspected in order to confirm that the worksite meets the safety standards. Further, the inspection also confirms that the surface is devoid of any potentially hazardous surface. This requires manual labor by trained personnel.

However, during operation of these machines at a worksite, an irregular and potentially hazardous surface may be created. As a result, other machines working at the worksite may be susceptible to accidents. For example, a milling machine working at a worksite may leave surface ridges that may be hazardous. The blade of a large tractor type truck used to push up the material after it is milled may inadvertently hit or catch on the ridge left by the milling machine causing the machine to decelerate rapidly and cause injury to the operator or damage to the machine.

US Publication 2013/0076101 discloses a transport device and a milling device. A sensor measures and monitors the distance between the milling device and the transport device and helps in maintaining a desired distance between milling device and the transport device.

### SUMMARY OF THE INVENTION

In an aspect of the present disclosure, a hazard avoidance system for a machine is disclosed. The hazard avoidance system includes a profile monitoring device configured to determine a profile created by the machine, a position detection module configured to determine a position of the machine on the worksite and a controller communicably coupled to the profile monitoring device and the position detection module. The controller is configured to receive the profile determined by the profile monitoring device, receive the position of the machine, determine the profile as a hazard if the gradient of the profile is above a certain gradient and determine the location of the hazard and transmit location of the hazard and initiate preventive action in a second machine operating in proximity to the machine on the worksite.

In yet another aspect of the present disclosure, a machine is disclosed. The machine includes a profile monitoring device configured to determine a profile created by the machine, a position detection module configured to determine a position of the machine on the worksite and a controller communicably coupled to the profile monitoring device and the position detection module. The controller is configured to receive the profile determined by the profile monitoring device, receive the position of the machine, determine the profile as a hazard if the gradient of the profile is above a certain gradient and determine the location of the hazard and transmit location of the hazard and initiate preventive action in a second machine operating in proximity to the machine on the worksite.

In yet another aspect of the present disclosure, a method of machine operation is disclosed. The method includes determining a profile created by the machine on a worksite, determining a position of the machine on the worksite, determining the profile as a hazard if the gradient of the profile is above a certain gradient and determining the location of the hazard and transmitting the location of the hazard and initiating preventive action in a second machine operating in proximity to the machine on the worksite.

### BRIEF DESCRIPTION OF THE DRAWINGS

FIG. 1 is a diagrammatic illustration of an exemplary disclosed machine that may operate at a worksite.

FIG. 2 illustrates a portion of the worksite having a first and second machine.

FIG. 3 illustrates an exemplary environment implementing a hazard avoidance system, according to an embodiment of the present disclosure.

FIG. 4 depicts a method of operating a machine equipped with hazard avoidance system.

### DETAILED DESCRIPTION

Reference will now be made in detail to embodiments of the invention, examples of which are illustrated in the accompanying drawings. Wherever possible, the same reference numbers will be used throughout the drawings to refer to the same or like parts.

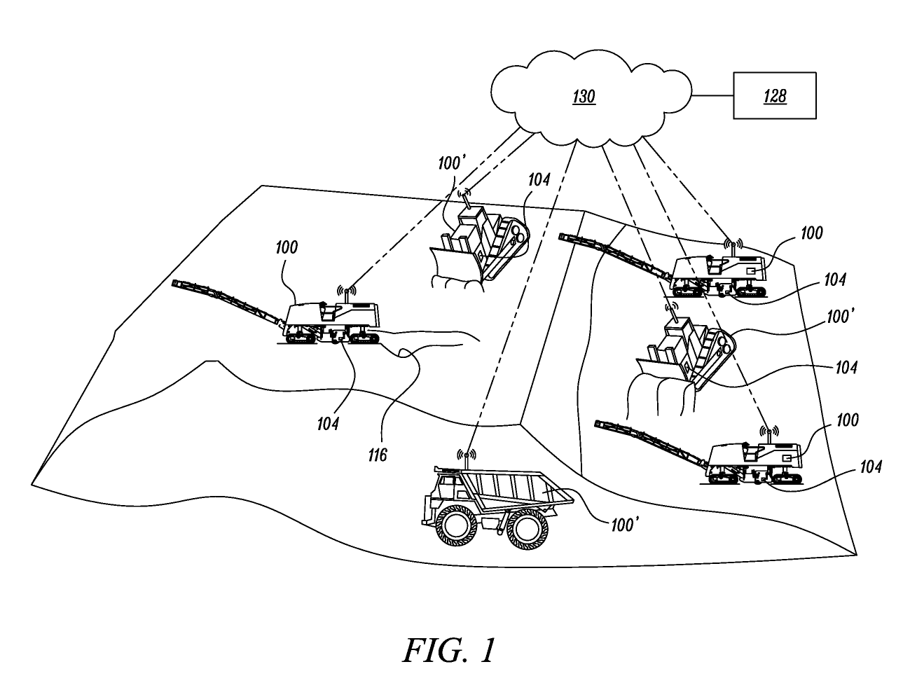

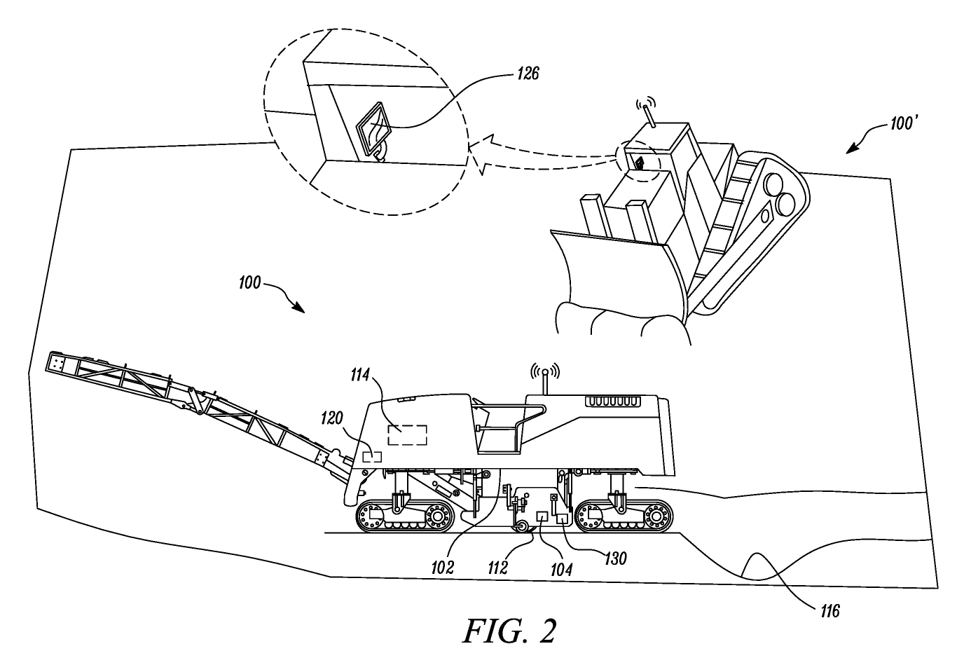

FIG. 1 illustrates an exemplary embodiment of a first machine 100 and a second machine 100′ working at a worksite, according to the present disclosure. The first machine 100 may be any machine used for surface altering operations such as motor graders, millers, dozers, compactors, pavers and profilers. However, other types of mobile machines may also be employed such as, transportation machines, inspection machines, etc. Referring to FIG. 2, the first machine 100, includes a work implement 112 configured to alter the surface of worksite. The work implement 112, shown as an earth working blade, is controllably and movably mounted on frame 102.

The second machine 100′ may be any machine that may be used on the worksite. The second machine 100′ may perform a secondary operation or may be a transport machine. The second machine 100′ may be a truck, a tractor-scraper, tractors in combination with trailers, or the like. The second machine may be configured to follow the first machine 100 to collect rubble generated by the first machine 100. In various other embodiments, the second machine 100′ may be any surface altering machine such as motor graders, millers, dozers, compactors, pavers, millers and profilers.

The first machine 100 includes an engine 114 which may be supported on a frame 102 of the first machine 100, as shown in FIG. 2. In the exemplary embodiment, the engine 114 may be an internal combustion engine. In various other embodiments, the engine 114 may be any engine running on solid, liquid or gaseous fuel and the like.

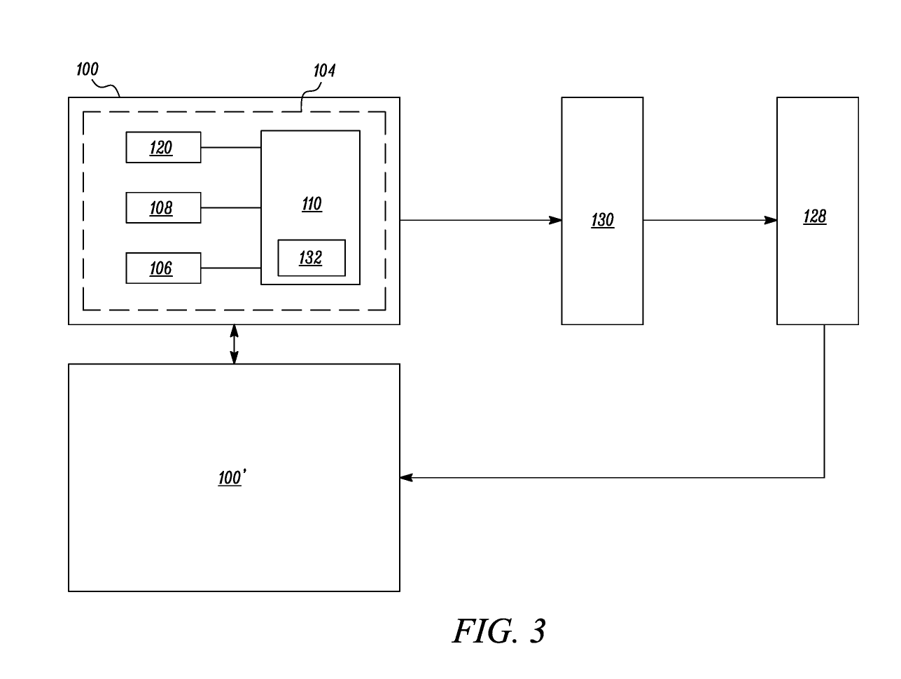

Referring to FIG. 3, a hazard avoidance system 104 is provided on the first machine 100. The hazard avoidance system 104 may be powered by the engine 114. Further, the engine 114 may be configured to provide power to a number of other systems and devices (not shown) in addition to the hazard avoidance system 104. In an alternate embodiment, the hazard avoidance system 104 may also be provided on the second machine 100′.

The hazard avoidance system 104 includes a profile monitoring device 106. The profile monitoring device 106 monitors the gradient of the profile that is created after the first machine 100 has performed the ground altering operation. The profile monitoring device 106 may be any image capturing device which may be configured to create an image feed of the surface after the first machine 100 has performed its surface altering operation. The image capturing device may be a camera, a video camera or any other imaging device known in the art. The profile monitoring device 106 may be disposed proximate to the work implement 112 to easily monitor the profile created by the first machine 100, as shown in FIG. 2. In an alternate embodiment, the profile monitoring device 106 may be disposed at the rear end of the first machine 100. In various other embodiments, the profile monitoring device 106 may be disposed at any other location on the first machine 100. In other embodiments, the profile monitoring device 106 may also determine a position of the image feed.

The hazard avoidance system 104 also includes a position detection module 108, as shown in FIG. 3. The position detection module 108 is configured to generate a signal of a current position of the associated machine on the worksite. In the embodiment illustrated, the position detection module 108 generates a signal of the current position of the first machine 100. The position detection module 108 may be any one or a combination of a Global Positioning System, a Global Navigation Satellite System, a Pseudolite/Pseudo-Satellite, any other Satellite Navigation System, an Inertial Navigation System or any other known position detection system known in the art.

In an embodiment, the first machine 100 may additionally include an orientation sensor 120 along with the position detection module 108, as shown in FIG. 3. The orientation sensor 120 is configured to generate a signal indicative of a heading direction and/or an inclination of the associated machine on the surface of the worksite. For example, the orientation sensor 120 may include a laser-level sensor, a tilt sensor, inclinometer, a radio direction finder, a gyrocompass, a fluxgate compass, or another known device.

The hazard avoidance system further includes a controller 110. The profile monitoring device 106, the position detection module 108 and the orientation sensor 120 may be communicably coupled to a controller 110, as shown in FIG. 3. In the embodiment illustrated, the controller 110 may be disposed on the first machine 100. Alternatively, the controller 110 may be located at a remote location.

The controller 110 is configured to receive information about the profile of the surface created by the first machine 100 from the profile monitoring device 106. The controller 110 is also configured to determine the position of the profile by either receiving the position signal for the profile from the position detection module 108 or the profile monitoring device 106.

In an embodiment, the profile monitoring device 106 may be activated based on signals from the controller 110. For example, the controller 110 may activate the profile monitoring device 106 corresponding to actuation of the first machine 100 or cessation of machine operation.

The controller 110 processes the information about the profile of the surface so as to determine whether the profile of the surface created by the first machine 100 meets safety standards. The controller 110 may possess an image processing technique or algorithm known in art in order to detect any irregularities in the profile of the surface that has been created.

The controller 110 determines whether the surface gradient of the profile created by the first machine 100 exceeds a certain threshold gradient value. A threshold gradient value for a profile is a value above which a profile may compromise the safety of the machine or the operator. For example, the threshold value may be determined by considering machine ground clearance and/or machine speed. For example, during operation the first machine 100 may create a profile on the surface having a certain gradient. The gradient may have a plurality of crests and troughs. The controller 110 receives the information about the crests and troughs from the profile monitoring device 106. The controller 110 then determines whether the crests and troughs of the profile exceed the certain threshold gradient value. When the threshold value is exceeded, the controller 110 determines the profile as a hazard 116.

Further, the controller 110 also determines the location of the hazard 116 using the position detection module 108 and may store it in a memory 132 not shown. In an alternate embodiment, the controller 110 may be coupled to one or more sensors or components of the first machine 100 to provide accurate coordinates or size of the hazard 116, as shown in FIG. 1 and FIG. 2. More particularly, based on one or more parameters associated with direction of travel or speed of the first machine 100, the controller 110 may determine the exact coordinates or size of the hazard 116.

The location of the hazard 116 created by the first machine 100 may be transmitted to the second machine 100′and preventive action is initiated in the second machine 100′ operating in proximity to the first machine 100 on the worksite. The controller 110 may transmit the location and initiate preventive action in the second machine 100′ over a peer-to-peer network or through a central server 128.

The controller 110 may transmit the location of the hazard 116 to second machine. This may include displaying the hazard on the display unit 126 of the second machine 100′. In an alternate embodiment, the area around the hazard 116 may be highlighted on a map being displayed on a display unit 126 of the second machine 100′.

The controller 110 may transmit the location of the hazard 116 created by the first machine 100 to the second machine 100′. Further, the controller 110 also initiates preventive action in the second machine 100′ operating in proximity to the first machine 100 on the worksite. In an alternate embodiment, the controller 110 may issue command or notification signals to the second machine 100′ to slow down the second machine 100′. In yet another embodiment, the controller 110 of the first machine 100 may halt the second machine 100′. In another embodiment the controller 110 may be configured to raise or maneuver the work tool of the second machine 100′. In various other embodiments, the first machine 100 may trigger an alarm in the second machine 100′ working in proximity to the first machine 100 to warn about the presence of the hazard 116.

Referring to FIG. 3, the controller 110 present on-board the first machine 100 may be communicably coupled to a central server 128 via a communication system 130. The communication system 130 may include a wide area network (WAN), a local area network (LAN), an Ethernet, Internet, an Intranet, a cellular network, a satellite network, or any other suitable network for transmitting data between the first machine 100, the second machine 100′ and the central server 128. In various embodiments, the communication system 130 may include a combination of two or more of the aforementioned networks and/or other types of networks known in the art. The communication system 130 may be implemented as a wired network, a wireless network or a combination thereof. Further, data transmission between the controller 110 and the central server 128 may occur over the communication system 130 in an encrypted or otherwise secure format, in any of a wide variety of known manners.

The central server 128 may be located on or away from the worksite. The central server 128 may be configured to receive and store data related to the profile of the surface created by the first machine 100. Further, the central server 128 may monitor the data received from the controller 110. The central server 128 may be configured to map the data related to the hazard 116 against a pre-calibrated data set of the worksite. This pre-calibrated data may include information related to co-ordinates of the existing hazards 116 on the worksite.

In one embodiment, the controller 110 instructs the central server 128 to transmit a command and the location of the hazard 116 created by the first machine 100 to the second machine 100′, as shown in FIG. 1. Further, the controller 110 initiates preventive action in the second machine 100′ operating in proximity to the first machine 100 on the worksite. In an alternate embodiment, the central server 128 may issue command or notification signals to the second machine 100′ to slow down, halt or raise the work tool of the second machine 100′.

In another embodiment, the first machine 100 may transmit the location of the hazard 116 directly to the second machine 100′. The first machine 100 may further be configured to initiate a preventive action in the second machine 100′. In one embodiment, the preventive action may be slowing down the second machine 100′ which is working in proximity to the first machine 100. In another embodiment, the preventive action may be bringing the second machine 100′ to a standstill. In yet another embodiment, the preventive action may also include triggering an alarm in the second machine 100′.

The controller 110 may embody a single microprocessor or multiple microprocessors that include a means for receiving signals from the profile monitoring device 106 and the position detection module 108. Numerous commercially available microprocessors may be configured to perform the functions of the controller 110. It should be appreciated that the controller 110 may readily embody a general machine microprocessor capable of controlling numerous machine functions. A person of ordinary skill in the art will appreciate that the controller 110 may additionally include other components and may also perform other functionalities not described herein.

The working of hazard avoidance system 104 along with the central server 128 will now be explained in detail with reference to FIG. 1 and FIG. 3. The first machine 100 may be operating at the worksite and may be performing surface altering operation. During operation the profile created by the work implement 112 of the first machine 100 is constantly monitored by the profile monitoring device 106. The data computed by the profile monitoring device 106 is transmitted to the controller 110. Using various algorithms and techniques, the controller 110 determines the presence of the hazard 116 in the surface altered by the first machine 100. The controller 110 then generates the location of the hazard 116 using the position detection module 108 and the location of the hazard 116 is then transmitted to the second machine 100′ though the central server 128. The controller 110 also initiates preventive action in the second machine 100′ working proximate to the first machine 100 and the hazard 116 to prevent an accident with the second machine 100′.

In yet another embodiment, the controller 110 of the first machine 100 may transmit commands to stop the second machine 100′ when the second machine 100′ is in close proximity to the hazard 116. In yet another embodiment of the present disclosure, the controller 110 of the first machine 100 may trigger an alarm in the second machine 100′ when the second machine 100′ is in close proximity to the hazard 116. In yet another embodiment, the controller 110 may also instruct the work implement 112 of the second machine to be raised to prevent damage.

In an alternate embodiment, the controller 110 of the first machine 100 may directly transmit the location to the hazard 116 to the second machine 100′. Further, the controller 110 of the first machine 100 may also transmit instructions to the second machine 100′ to slow down the second machine 100′ thereby preventing the second machine 100′ passing through the hazard 116.

In an alternate embodiment, the second machine 100′ may also be a surface altering machine which may create a hazard 116 during operation. Further, the second machine 100′ may also include the hazard avoidance system 104. In this case, the hazard avoidance system 104 of the second machine 100′ transmits the location of the hazard 116 to the first machine 100 working proximate to the second machine 100′. Further, the hazard avoidance system 104 also initiates preventive action in the first machine 100 working proximate to the second machine 100′.

In yet another embodiment, a plurality of machines may be working on the worksite. Each machine may be equipped with the hazard avoidance system 104. The hazard avoidance system of each machine may warn other machines working on the worksite about the hazard 116 created during operation. The hazard avoidance system 104 of each machine may create an outline/demarcation on a map where the hazards 116 are located. Each map created by the hazard avoidance system of the associated machine may be stored on the central server 128. Using these maps, the map being displayed on the display unit 126 may be updated to show the location of the hazards created by various machines on the worksite.

### INDUSTRIAL APPLICABILITY

Machines such as motor graders, dozers, compactors, pavers, and profilers to name a just a few, may be used for geographic surface altering operations. During operation, these machines may create an irregular and potentially hazardous surface. Due to these irregular surfaces, other machines working at the worksite may be working in a high risk zone thereby being susceptible to accidents.

In an aspect of the present disclosure, the hazard avoidance system 104 is disclosed. The hazard avoidance system 104 may be provided on the first machine 100. The hazard avoidance system 104 has profile monitoring device 106, position detection module 108 and controller 110. The hazard avoidance system 104 warns the second machine 100′ about the presence of a hazard 116 created by the first machine 100 during operation. The controller 110 of the hazard avoidance system 104 may even instruct the second machine 100′ to slow down or in some cases halt the second machine 100′ to avoid any mishap.

In another aspect of the present disclosure, the hazard avoidance system 104 on the first machine 100 may warn a plurality of machines working on the same worksite about the presence of the hazard 116.

In yet another aspect of the present disclosure, the controller 110 of the first machine 100 may trigger an alarm in the second machine 100′ when the second machine 100′ is in close proximity to the hazard 116. The controller 110 of the first machine 100 also instructs the work implement 112 to be raised to prevent the work implement 112 from getting jammed in the hazard 116.

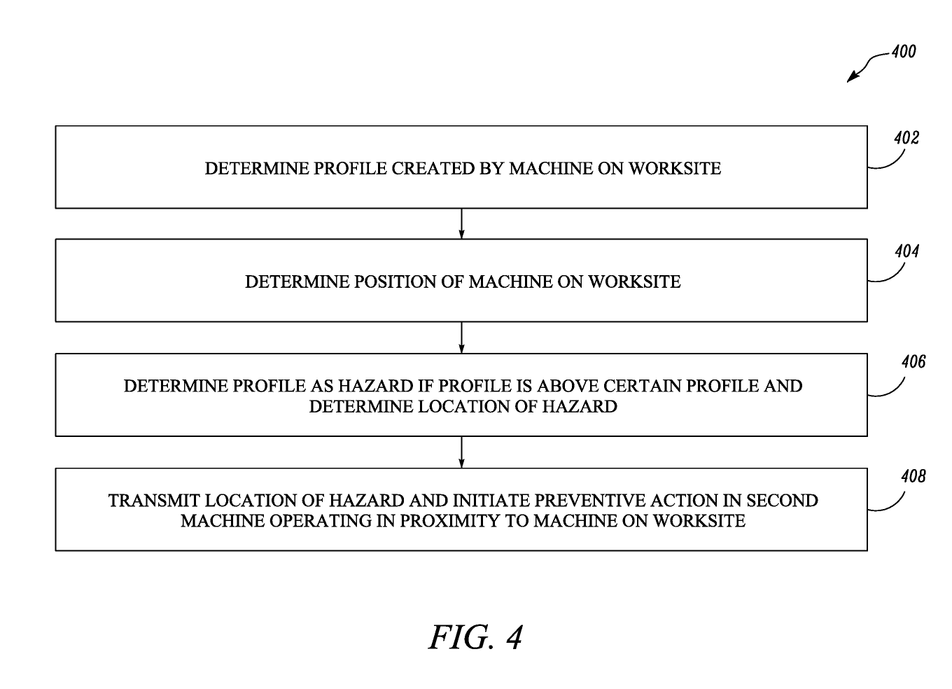

The method 400 of warning machines present in the worksite will now be described in detail with reference to FIG. 4. The profile monitoring device 106 monitors the profile created after operation by the first machine 100 (Step 402). Simultaneously, the location/coordinates of the first machine 100 are determined (Step 404). The profile monitored by the profile monitoring device 106 is then fed to the controller 110. The controller 110 uses multiple algorithms and determines the profile as a hazard 116 if the profile of the surface exceeds a certain threshold. The location of the hazard 116 is also calculated using the data captured by the controller 110 (Step 406). The location of the hazard 116 is then transmitted to the second machine 100′ and simultaneously preventive action is initiated in the second machine 100′ which is operating in close proximity to the first machine 100 (Step 408).

While aspects of the present disclosure have seen particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A hazard avoidance system for a machine operating on a worksite, the hazard avoidance system comprising:
a profile monitoring device configured to determine a profile created by a surface altering machine;
a position detection module configured to determine a position of the machine on the worksite;
a controller communicably coupled to the profile monitoring device and the position detection module, the controller configured to:
receive the profile determined by the profile monitoring device;
receive the position of the machine;
determine the profile as a hazard if the gradient of the profile is above a certain gradient and determine the location of the hazard; and
transmit location of the hazard and initiate preventive action in a second machine operating in proximity to the machine on the worksite.

2. The hazard avoidance system of claim 1, wherein the profile monitoring device includes detecting that the cutting devices has been raised above a specified threshold while it is cutting.

3. The hazard avoidance system of claim 1, wherein initiating preventive action in a second machine includes slowing down the second machine.

4. The hazard avoidance system of claim 1, wherein initiating preventive action in a second machine includes raising its implement.

5. The hazard avoidance system of claim 1, wherein initiating preventive action in a second machine includes triggering an alarm in the second machine.

6. The hazard avoidance system of claim 1, wherein the location of the hazard is directly transmitted to the second machine.

7. The hazard avoidance system of claim 1, wherein the location of the hazard is directly transmitted to a central server.

8. A machine comprising:
a profile monitoring device configured to determine a profile created by the machine;
a position detection module configured to determine a position of the machine;
a controller communicably coupled to the profile monitoring device and the position detection module, the controller configured to:
receive the profile determined by the profile monitoring device;
receive the position of the machine;
determine the profile as a hazard if the gradient of the profile is above a certain gradient and determine the location of the hazard; and
transmit location of the hazard and initiate preventive action in a second machine operating in proximity to the machine.

9. The machine of claim 8, wherein initiating preventive action in a second machine includes slowing down the second machine.

10. The machine of claim 8, wherein initiating preventive action in a second machine includes raising its implement.

11. The machine of claim 8, wherein initiating preventive action in a second machine includes triggering an alarm in the second machine.

12. The machine of claim 8, wherein the second machine is in close proximity to the hazard.

13. The machine of claim 8, wherein location of the hazard is directly transmitted to the second machine.

14. The machine of claim 8, wherein location of the hazard is directly transmitted to a central server.

15. A method of machine operation comprising:
determining by a profile monitoring device a profile created by the machine on a worksite;
determining by a position detection module a position of the machine on the worksite;
determining the profile as a hazard using a controller if the gradient of the profile is above a certain gradient and determining the location of the hazard; and
transmitting the location of the hazard using the controller and initiating preventive action in a second machine operating in proximity to the machine on the worksite.

16. The method of claim 15 wherein initiating preventive action in a second machine includes slowing down the second machine.

17. The method of claim 15 wherein initiating preventive action in a second machine includes raising its implement.

18. The method of claim 15 wherein initiating preventive action in a second machine includes triggering an alarm in the second machine.

19. The method of claim 15 further comprising transmitting the location of the hazard directly to the second machine.

20. The method of claim 15 further comprising transmitting the location of the hazard to a central server.
